(19) United States
(12) Patent Application Publication
(10) Pub. No.: US 2013/0030602 A1
(43) Pub. Date: Jan. 31, 2013

(54) LANE ASSISTANCE SYSTEM USING AN IN-WHEEL SYSTEM

(71) Applicant: Ji Yoel Joeng, Gwangmyeong (KR)

(72) Inventor: Ji Yoel Joeng, Gwangmyeong (KR)

(73) Assignee: HYUNDAI MOTOR COMPANY, Seoul (KR)

(21) Appl. No.: 13/314,870

(22) Filed: Dec. 8, 2011

(30) Foreign Application Priority Data
Jul. 28, 2011 (KR) 10-2011-0075163

(51) Int. Cl. G06F 7/00

(52) U.S. Cl. 701/1

(57) ABSTRACT

A lane assistance system using an in-wheel system according to an exemplary embodiment of the present invention may include determining a lane deviation danger of a vehicle whether a vehicle is in danger of deviating from a lane, calculating a necessary yaw rate to assist a driver in maintaining a the vehicle in the intended lane of travel, calculate a demand yaw rate through a difference between the calculated necessary yaw rate and an actual yaw rate, and calculate a distribution amount of a driving torque of torque vectoring for achieving the demand yaw rate. In doing so, the lane assistance system controls the torque selectively applied to each wheel according to the above calculations.

### CROSS-REFERENCE TO RELATED APPLICATION

This application claims priority to and the benefit of Korean Patent Application No. 10-2011-0075163 filed in the Korean Intellectual Property Office on Jul. 28, 2011, the entire contents of which are incorporated herein by reference.

### BACKGROUND OF THE INVENTION

(a) Field of the Invention

The present invention relates to lane assistance system using an in-wheel system. More particularly, the present invention relates to a lane assistance system that calculates a demand yaw rate and distributes a driving torque of a torque vector to prevent a vehicle from straying out of its intended lane.

(b) Description of the Related Art

A lane assistance system (LAS) is a driver aide to alert a driver that the car is straying from its intended lane of travel and prevent accidents. In general, LAS systems detect when a vehicle has drifted into an adjacent lane of travel and a lane change signal has not been activated by the driver due to e.g., the driver dozing off or not paying attention, an emergency sound is generated and then a steering force is applied to a steering system to help the driver stay in the traffic lane and hopefully avoid an accident.

The LAS (1) detects numerous points of vehicle data, e.g., a steering angle, vehicle speed, and yaw rate through various sensors located throughout the vehicle, (2) uses the data collected as input signals, (3) predicts vehicle movement through a control logic unit that detects and monitors a lane, a curvature radius, a deviation angle, a lateral displacement, etc., and determines intervention timing at which time the steering system compensates for the lane departure by applying a steering torque calculated by the control logic unit. The compensation of the steering torque is typically performed by motor drive power steering (MDPS). In this case, a camera can be disposed on a vehicle to detect and recognize a traffic lane.

In the conventional art, when a steering torque is applied against the force of the driver, the driver can feel repulsion in steering wheel, and further, when an excessive assist steering torque is applied thereto by a calculation error, movement of the vehicle may become unsafe and over compensating, unfortunately causing accidents in extreme cases. Accordingly, additional measures are necessary to ensure the integrity of the system.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a lane assistance system which is able to minimize repulsion felt by a driver from the system by controlling torque vectoring according to a yaw rate. A lane assistance system using an in-wheel system according to an exemplary embodiment of the present invention may include a control device, e.g., a controller that is configured to determine when a vehicle is in danger of deviating from a lane, calculate a necessary yaw rate for assisting in maintaining the vehicle in the lane, calculate a demand yaw rate through a difference between the calculated necessary yaw rate and an actual yaw rate, and calculate a distribution amount of a driving torque from torque vectoring to achieve a demand yaw rate.

The lane deviation may be detected by an increment of a lateral displacement or a relative yaw angle or alternatively by the relative yaw angle and speed of a vehicle in a case of the relative yaw angle.

The necessary yaw rate may be achieved by a calculation of a predicted deviation amount that is caused by the lateral displacement and the relative yaw angle. The demand yaw rate may be calculated by the equation below.

$${δ}_{desired} = \frac{L Δ \dot{Ψ}}{V}$$

Here, δ_{desired} is a demand yaw rate. Δ\dot{ψ} is a difference between a demand yaw rate and an actual yaw rate. V is a vehicle speed, and L is a track (distance between wheels) of a vehicle.

The distribution amount of the torque vectoring driving torque may be set by adding a distribution amount of a driving torque of a torque vectoring through a deviation amount and a driving torque of torque vectoring through a road curvature. The distribution amount of a driving torque of torque vectoring through the deviation amount may be calculated by the equation below.

$${F}_{TV 1} = \frac{M}{t} = \frac{{K}_{p} Δ \dot{Ψ}}{t}$$

Here, F_{TV1} is a driving torque distribution amount through a deviation amount. M is a demand moment. Kₚ is a proportional coefficient, and t is a tread (a distance between left/right tires).

The driving torque distribution amount of torque vectoring through the road curvature may be calculated through road curvature and vehicle speed. Control timing may be determined by the demand yaw rate when, for example, the vehicle speed is more than 40 km/h or/and when the demand yaw rate is larger than a predetermined value.

An exemplary embodiment of the present invention uses the change in torque applied to a rear wheel rather than applying a steering wheel torque to the steering wheel when a vehicle deviates from a lane so that repulsion is not transferred to a driver. That is, the present invention uses a change in torque applied to a rear wheel to minimize the repulsion felt by a driver in a steering wheel.

Additionally, a vision device may add to the in-wheel system which may be incorporated into an electronic driving system in the vehicle as well.

### BRIEF DESCRIPTION OF THE DRAWINGS

FIG. 1 shows a lane assistance system according to an exemplary embodiment of the present invention.

FIGS. 2A, B shows a danger of departure from a traffic lane according to an exemplary embodiment of the present invention.

FIG. 3 shows a movement of a vehicle by a control according to an exemplary embodiment of the present invention.

FIG. 4 shows a procedure in which a vehicle maintains a traffic lane by a control according to an exemplary embodiment of the present invention.

### DETAILED DESCRIPTION OF THE EMBODIMENTS

Hereinafter, with reference to the accompanying drawings, the present invention will be described in order for those skilled in the art to be able to implement the invention.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

A lane assistance system according to an exemplary embodiment of the present invention uses an in-wheel system to keep a vehicle from unintentionally departing from its intended lane of travel. More specifically, the in-wheel includes a motor that is disposed in or around each wheel of a vehicle to direct operation of the wheel or independently control the drive torque applied to the wheel based upon a lane assistance system detecting that a vehicle is beginning to depart from its intended lane of travel. The in-wheel system independently operates each wheel and independently controls torque of a front/rear/left/right wheel to improve movement and performance of a vehicle, and particularly, to be able to independently control the steering of the wheels. This is achieved by a lateral force that is generated by controlling a torque difference between left and right wheels.

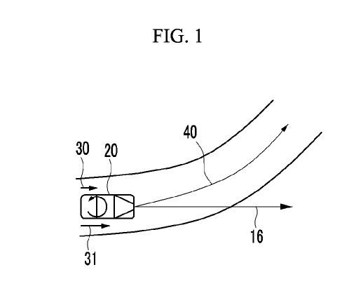

Hereinafter, a lane assistance system will be described according to an exemplary embodiment of the present invention. Firstly, FIG. 1 is a figure for describing a lane assistance system using an in-wheel system, and what occurs when a vehicle 20 turns on a curved road. The reference numeral 16 is a straight direction line and reference numeral 40 is the moving direction of the vehicle. If, for example, it is determined that there is a danger that a vehicle could leave the intended lane of travel, driving torque 31 of an outer rear wheel of a turn is increased and driving torque 30 of an inner rear wheel of a turn is reduced to increase a yaw moment in a turning direction so that the vehicle moves appropriately through a curve without departing from the intended lane of travel.

The lane assistance system according to an exemplary embodiment of the present invention determines a danger condition of a lane deviation while driving, and if it is determined that a vehicle is in approaching dangerous conditions, e.g., departing into an unintended lane of traffic, the illustrative embodiment of the present invention calculates a necessary yaw rate for maintaining the vehicle in its intended lane, calculates a demand yaw rate between the calculated necessary yaw rate and the actual yaw rate, and calculates a distribution amount of a torque vectoring driving torque to achieve the demand yaw rate so that the vehicle safely maintains its intended lane of travel.

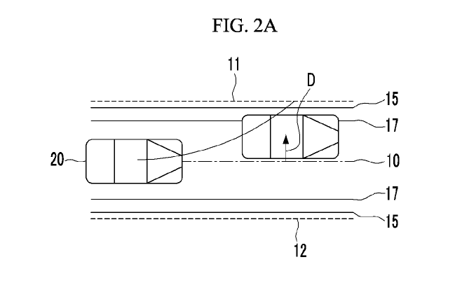

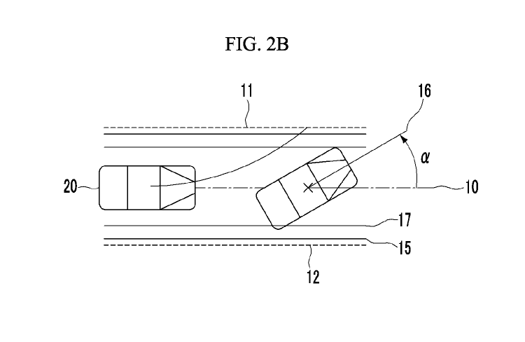

FIGS. 2A and B illustrate a drawing for describing a danger of a lane deviation, wherein the danger of the lane deviation is determined by a lateral displacement (D) across a road. FIG. 2A is used for describing a danger of a lane deviation based on a lateral displacement of the vehicle, and when the lateral displacement is increased due to the vehicle straying to the left hand side of FIG. 2A and reaches a left lane 11 thereby coming into contact with a deviation danger line 15, it is determined that there is a danger of lane deviation. The system applies a torque which causes the vehicle to move to an inner side of a deviation danger release line 17 through steering control.

Also, in addition to the method that determines a danger of a lane deviation of a vehicle 20 through the lateral displacement (D), as shown in FIG. 2B, the danger of a vehicle lane deviation can be determined by a relative yaw angle (a) and speed of the vehicle 20. That is, as the relative yaw angle and the vehicle speed increases, the danger of the lane deviation increases, and as the relative yaw angle and the vehicle speed decreases, the danger of the lane deviation decreases.

Here, the relative yaw angle (α) denotes an angle that is formed by a center line 10 of a road and a straight direction line 16 of the vehicle 20 in FIG. 2B. The relative yaw angle can be generated by driver vehicular manipulation, lateral wind, or the surrounding environment. This yaw rate is measured by a steering angle sensor or any other type of sensor capable of measuring the yaw rate of a vehicle.

The straight direction line 16 of the vehicle 20 signifies a frontal direction of the vehicle 20 regardless of the turning direction of the vehicle 20. Here, it is necessary to compensate the danger of the lane deviation.

Hereinafter, a method for maintaining a lane according to an exemplary embodiment of the present invention will be described.

The method includes calculating a necessary yaw rate so as to assist a driver in maintaining the vehicle in its intended lane of travel, which can be determined by calculating a predicted deviation amount that is caused by a lateral displacement (D) and a relative yaw angle.

This is calculated by Equation 1 below.

$${\dot{Ψ}}_{p} = \frac{{\dot{Ψ}}_{p}}{{T}_{p}} \qquad ( 1 )$$

In the above Equation 1, \dot{ψ}ₚ is a necessary yaw rate, ψₚ is a predicted deviation amount, and Tₚ is a predicted time. That is, the necessary yaw rate signifies a ratio of a yaw rate that is predicted and that deviates for a predetermined time.

Then, a demand yaw rate is calculated by a difference between the necessary yaw rate that is calculated by the equation and the actual yaw rate, and the demand yaw rate is calculated by Equation 2 below.

$${δ}_{desired} = \frac{L Δ \dot{Ψ}}{V} \qquad ( 2 )$$

In the above Equation 2, δ_{desired} is a demand yaw rate, L is a right/left wheel distance of a vehicle 20, V is vehicle speed, and Δ\dot{ψ} is a difference between the necessary yaw rate and the actual yaw rate. That is, Δ\dot{ψ}=\dot{ψ}ₚ−\dot{ψ}ₐ, wherein \dot{ψ}ₚ is a necessary yaw rate and \dot{ψ}ₐ is an actual yaw rate.

A control intervention timing can be determined by the demand yaw rate. For example, if the demand yaw rate is greater than a predetermined value, the system intervenes in the control to maintain the vehicle in its intended lane of travel.

Also, a demand yaw moment is calculated to achieve the demand yaw rate according to an exemplary embodiment of the present invention, and a distribution amount of a torque vectoring driving torque is calculated to achieve this. Here, the driving torque distribution amount of the torque vectoring is calculated by adding a distribution amount of a torque vectoring driving torque through a deviation amount and a distribution amount of a torque vectoring driving torque through a road curvature. The torque vectoring driving torque by the deviation amount is compensated for by a deviation through the road curvature.

The driving torque distribution amount of the torque vectoring through the deviation amount is calculated by Equation 3 below.

$${F}_{TV 1} = \frac{M}{t} = \frac{{K}_{p} Δ \dot{Ψ}}{t} \qquad ( 3 )$$

In the above Equation 3, F_{TV1} is a driving torque distribution amount of torque vectoring through a deviation amount, M is a demand moment, Kp is a proportional coefficient, and t is a tread.

Also, the driving torque distribution amount of the torque vectoring through the road curvature is calculated by the road curvature and the vehicle's speed, which is calculated by Equation 4 below.

F_{TV2}=f(k,V) (4)

In the above Equation 4, F_{TV2} is a driving torque distribution amount of torque vectoring by a road curvature, k is a road curvature, and V is a speed of a vehicle 20. Here, the road curvature can be calculated by a camera sensor. The driving torque distribution amount of the torque vectoring that is calculated by the above method is used to maintain the lane.

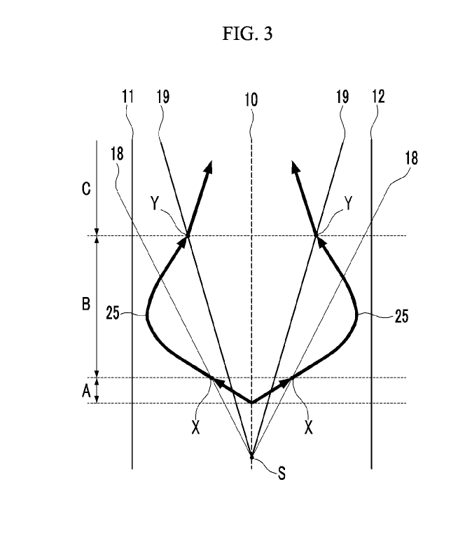

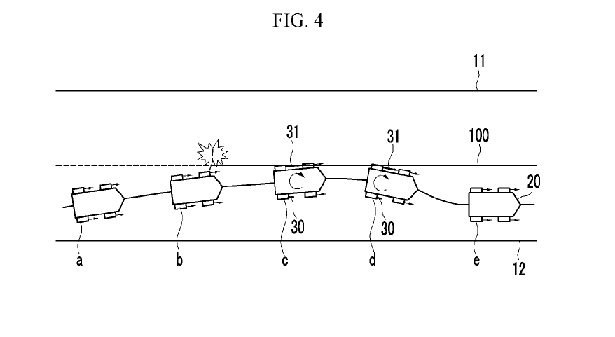

Hereinafter, referring to FIG. 3 and FIG. 4, an exemplary embodiment of the present invention will be described.

FIG. 3 shows a movement of a vehicle through a control system and method according to an exemplary embodiment of the present invention, and FIG. 4 shows a procedure for maintaining a vehicle in its intended lane of travel through a control according to an exemplary embodiment of the present invention.

Firstly, in FIG. 3, an “A” section is a portion where a vehicle starts to deviate from a lane, a “B” section is a torque vectoring operation portion, a “C” section is a driver steering portion, and an “S” section is a present point of a vehicle. While the vehicle moves in a left lane 11 or a right lane 12, when the vehicle reaches a predetermined timing point (X), the control is started. This is a point when a vehicle moving line 25 meets a control (intervention) start line 18. For example, if the vehicle speed is greater than 40 km/h and the steering angle exceeds a predetermined value (for example, 17°), the control system, e.g., a controller, starts to intervene.

In the “B” section from this point (X), the system controls the vehicle according to the torque vectoring distribution amounts F_{TV1} and F_{TV2} to assist the driver in maintaining vehicle in the lane. Once the vehicle moves into an inner side of the lane through the vehicle assistance, the control intervention is released. That is, intervention control is released at a point where a control release line 19 intersects the vehicle moving line 25, particularly if the steering angle is greater than a predetermined value (for example, 14°). After the control is released, a driver may again normally operate the vehicle in the “C” section, because there is no longer any danger of the vehicle deviating from the traffic lane.

FIG. 4 shows a movement of a vehicle 20 along a control section according to an exemplary embodiment of the present invention. A vehicle starts to approach a central line 100 from a point “a”, it is determined whether intervention control is needed at a point “b” where the vehicle 20 comes close to the central line 100. If the control system intervenes by the determination of the lane deviation danger, the control is performed according to an exemplary embodiment of the present invention.

The control controls the vehicle according to the torque vectoring distribution amount calculated in “c”, the vehicle 20 is guided toward the central area of the lane to so that the vehicle does not cross the central line 100 in “d”, and then if it is determined that further control is not necessary in “e”, the control is released. In this case, the driving torque of the torque vectoring controls the system such that the driving torque 31 of the outer rear wheel becomes greater than the driving torque 30 of the inner side rear wheel.

As described above, the driving torque of the rear (front) wheel is used to make the vehicle stay within the lane thereof while at the same time preventing the driver from being a repulsion or additionally applied force in the steering wheel thereof.

Furthermore, the present invention may be embodied as computer readable media on a computer readable medium containing executable program instructions executed by a control device such as a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, such as a telematics server and controller area network.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

10: center line
11: left side lane
12: right side lane
15: deviation danger
16: front direction line
17: deviation danger release line
18: control start line
19: control release line
20: vehicle
25: vehicle moving line
30: driving torque of inner side rear wheel
31: driving torque of outer side rear wheel
40: moving direction
α: relative yaw rate
A: lane deviation start section
B: torque vectoring operation section
C: driver steering section
D: lateral displacement
S: present position
100: central lane

What is claimed is:

1. A method for maintaining a vehicle in an intended lane, comprising:
determining, by a controller, whether a vehicle is in danger of deviating from an intended lane of travel;
calculating, by the controller, a necessary yaw rate for assisting a driver in staying within the intended lane of travel;
calculating, by the controller, a demand yaw rate based on a difference between the calculated necessary yaw rate and an actual yaw rate; and
calculating, by the controller, a distribution amount of a driving torque of torque vectoring to calculate the demand yaw rate.

2. The method of claim 1, wherein determining whether the vehicle is in danger of deviating from its intended lane is determined by an increment of a lateral displacement or a relative yaw angle.

3. The method of claim 2, wherein determining whether the vehicle is in danger of deviating from its intended lane is determined by the relative yaw angle and a speed of a vehicle in a case of the relative yaw angle.

4. The method of claim 1, wherein the necessary yaw rate is calculated by calculating a predicted deviation amount caused by the lateral displacement and the relative yaw angle.

5. The method of claim 1, wherein the demand yaw rate is calculated by an equation below:
$${δ}_{desired} = \frac{L Δ \dot{Ψ}}{V}$$
where δ_{desired} is a demand yaw rate, Δ\dot{ψ} is a difference between a demand yaw rate and an actual yaw rate, V is a vehicle speed, and L is a distance between wheels of a vehicle.

6. The method of claim 1, wherein the distribution amount of the torque vectoring driving torque is set by adding a distribution amount of a driving torque of torque vectoring through a deviation amount and a driving torque of torque vectoring through a road curvature.

7. The method of claim 6, wherein the distribution amount of a driving torque of a torque vectoring through the deviation amount is calculated by the equation below:
$${F}_{TV 1} = \frac{M}{t} = \frac{{K}_{p} Δ \dot{Ψ}}{t}$$
where F_{TV1} is a driving torque distribution amount through a deviation amount, M is a demand moment, Kₚ is a proportional coefficient, and t is a tread.

8. The method of claim 6, wherein the driving torque distribution amount of torque vectoring through the road curvature is calculated by a road curvature and a vehicle speed.

9. The method of claim 1, wherein control timing is determined by the demand yaw rate.

10. The method of claim 9, wherein the control timing is determined when that the vehicle speed is more than 40 km/h.

11. The method of claim 1, wherein the control timing is determined when the demand yaw rate is larger than a predetermined value.

12. A computer readable medium containing executable program instructions executed by a control device, comprising:
program instructions that determine whether a vehicle is in danger of deviating from an intended lane of travel;
program instructions that calculate a necessary yaw rate for assisting a driver in staying within the intended lane of travel;
program instructions that calculate a demand yaw rate based on a difference between the calculated necessary yaw rate and an actual yaw rate; and
program instructions that calculate a distribution amount of a driving torque of torque vectoring to calculate the demand yaw rate.

13. A lane assistance system, comprising:
a controller configured to determine whether a vehicle is in danger of deviating from an intended lane of travel, calculate a necessary yaw rate for assisting a driver in staying within the intended lane of travel, calculate a demand yaw rate based on a difference between the calculated necessary yaw rate and an actual yaw rate, and calculate a distribution amount of a driving torque of torque vectoring to calculate the demand yaw rate; and
a plurality of motors operably connected to each wheel of the vehicle and each motor of the plurality of motors configured to selectively apply a torque to each wheel of the vehicle depending upon the calculated distribution amount.

14. The lane assistance system of claim 13, wherein determining whether the vehicle is in danger of deviating from its intended lane is determined by an increment of a lateral displacement or a relative yaw angle.

15. The lane assistance system of claim 14, wherein determining whether the vehicle is in danger of deviating from its intended lane is determined by the relative yaw angle and a speed of a vehicle in a case of the relative yaw angle.

16. The lane assistance system of claim 13, wherein the necessary yaw rate is calculated by calculating a predicted deviation amount caused by the lateral displacement and the relative yaw angle.

17. The lane assistance system of claim 13, wherein the demand yaw rate is calculated by an equation below:
$${δ}_{desired} = \frac{L Δ \dot{Ψ}}{V}$$
where δ_{desired} is a demand yaw rate, Δ\dot{ψ} is a difference between a demand yaw rate and an actual yaw rate, V is a vehicle speed, and L is a distance between wheels of a vehicle.

18. The lane assistance system of claim 13, wherein the distribution amount of the torque vectoring driving torque is set by adding a distribution amount of a driving torque of torque vectoring through a deviation amount and a driving torque of torque vectoring through a road curvature.

19. The lane assistance system of claim 18, wherein the distribution amount of a driving torque of a torque vectoring through the deviation amount is calculated by the equation below:
$${F}_{TV 1} = \frac{M}{t} = \frac{{K}_{p} Δ \dot{Ψ}}{t}$$
where F_{TV1} is a driving torque distribution amount through a deviation amount, M is a demand moment, Kₚ is a proportional coefficient, and t is a tread.

20. The lane assistance system of claim 18, wherein the driving torque distribution amount of torque vectoring through the road curvature is calculated by a road curvature and a vehicle speed.

21. The lane assistance system of claim 13, wherein control timing is determined by the demand yaw rate.

22. The lane assistance system of claim 21, wherein the control timing is determined when the vehicle speed is more than 40 km/h.

23. The traffic lane assistance system of claim 13, wherein the control timing is determined when the demand yaw rate is larger than a predetermined value.
